(19) United States
(12) Patent Application Publication
(10) Pub. No.: US 2024/0069211 A1
(43) Pub. Date: Feb. 29, 2024

(54) METHOD FOR DETERMINING, USING AN OPTRONIC SYSTEM, POSITIONS IN A SCENE, AND ASSOCIATED OPTRONIC SYSTEM

(71) Applicant: THALES, Courbevoie (FR)

(72) Inventors: Alain SIMON, Elancourt Cedex (FR); Arnaud BECHE, Elancourt Cedex (FR); Jean SOULA, Elancourt Cedex (FR); Pierre-Yves GUINET, Elancourt Cedex (FR); Pascal JEROT, Elancourt Cedex (FR)

(21) Appl. No.: 18/269,924

(22) PCT Filed: Dec. 28, 2021
(86) PCT No.: PCT/EP2021/087745

§ 371 Date: Jun. 27, 2023

(30) Foreign Application Priority Data
Dec. 29, 2020 (FR) FR2014216

(51) Int. Cl. G01S 19/31; G01C 17/12; G01C 17/38; G06T 7/70

(52) U.S. Cl. CPC G01S 19/31; G01C 17/12; G01C 17/38; G06T 7/70

(57) ABSTRACT

The present invention relates to a method for determining positions by an optronic system in a scene, the scene comprising reference elements of known geographic coordinates, the optronic system comprising the following elements integrated into said optronic system:
a. a digital imager,
b. a memory wherein is stored, for each reference element of the scene, an indicator representative of said point associated with the geographic coordinates of said point,
c. a display element that displays the indicators stored in the memory,
d. a measurement module comprising at least one element chosen from among: a compass, a goniometer and a telemeter,
e. a calculation unit,
the method being implemented by the elements integrated in the optronic system.

The present invention relates to a method for determining at least one position, by an optronic system, in a scene. The present invention also relates to such an optronic system.

When monitoring a scene of operations, the determination of positions, whether local or remote, allows to have information on elements of interest in the scene, and possibly enables action to be taken against such elements. Thus, the more precise the positions determined, the better the control of the situation.

In particular, it is known to determine such positions as a function of the measurements carried out by an optronic system on the elements of the scene, and the position of the optronic system obtained by a Geolocation and Navigation Satellite System (GNSS).

However, the accuracy of the position obtained by the GNSS is not always sufficient, depending on the application. In addition, GNSS signals are susceptible to being altered without the receiver or operator being aware of the alteration or may even be unavailable. Examples of GNSS signal alterations are, for example, attributable to interference by parasitic signals, masking by infrastructure or multiple reflections of the GNSS signal. GNSS systems are also susceptible to deception by third parties.

There is therefore a need for an optronic system that enables positions to be determined in a more accurate and robust manner.

To this end, the invention has as its object a method for determining at least one position by an optronic system in a scene, the scene comprising reference elements of known geographical coordinates, the optronic system comprising the following elements integrated into said optronic system:
a digital imager,
a memory in which is stored, for at least each reference element of the scene, an indicator representative of said point associated with the geographical coordinates of said point,
an element for displaying the indicators stored in the memory,
a measurement module comprising at least one element chosen from among: a compass, a goniometer and a telemeter,
a calculation unit,
the method being implemented by the elements integrated in the optronic system and comprising:
   a data collection phase relating to at least one reference element in the scene, the
collection phase comprising, for each reference element, the steps of:
pointing, by the digital imager, of the reference element in the scene,
acquisition, by the measurement module, of at least one measurement relative to the reference element pointed in the scene, following reception of a first acquisition command,
pointing, on the display element, from among the stored indicators, of an indicator representative of the reference element pointed in the scene,
acquisition, by the calculation unit, of the geographic coordinates associated with the pointed indicator following reception of a second acquisition command,
storage of a datum, called reference, comprising the at least one acquired measurement and the acquired geographic coordinates,
   a phase of determining the position of the optronic system as a function of the reference data stored for the at least one reference element.

According to other advantageous aspects of the invention, the method comprises one or more of the following features, taken alone or in any technically possible combination:
the indicators stored in the memory are points geo-referenced on geographic data, the geographic data comprising at least one element from among: an orthoimage of the scene, a digital terrain model of the scene, a cartography of the scene and a digital elevation model of the scene, the memory preferably comprising, in addition to the indicators of the reference elements, indicators of all the points geo-referenced on the geographic data;
the step of pointing an indicator comprises displaying on the display element:
   the image of the scene comprising the reference element pointed by the digital imager, and
   the indicators stored in the memory;
the phase of determining the position of the optronic system comprises the selection, by the calculation unit, of a position determination technique from among a set of position determination techniques as a function of the nature of the element or elements of the measurement module having acquired the at least one measurement corresponding to the reference data, the position of the optronic system being determined on the basis of the selected determination technique;
each element of the measurement module is associated with a measurement uncertainty and each geographic coordinate is associated with an uncertainty on said geographic coordinate, the phase of determining the position of the optronic system comprising the determination of an uncertainty on the position determined as a function of the corresponding uncertainties on the at least one element of the measurement module and on the geographic coordinates;
the phase of determining the position of the optronic system comprises the calculation of an approximate position of the optronic system as a function of stored reference data and calculating an optimum position of the optronic system from the approximate position and all the reference data;
the phase of determining the position of the optronic system comprises the evaluation of the integrity of the reference data, and determining a position having integrity as a function of only the reference data evaluated as having integrity, and the calculated optimum position;
the optronic system comprises a receiver for geolocation and navigation by a satellite system, called GNSS receiver, the method comprising a phase of determining the position of the optronic system by the GNSS receiver, called GNSS position, and of validating or not the GNSS position according to a position of the optronic system determined via the reference data, advantageously when the GNSS position has been validated, the method comprises merging the GNSS position with the position of the optronic system determined via the reference data used for the comparison so as to obtain a definitive position for the optronic system;
the measurement module comprises an odometric goniometer or an odometric compass, at least one measurement acquired relative to the reference elements being an orientation measurement, the measurement acquisition step comprising:
a. the acquisition of a series of images of the scene, the series of images comprising at least one image of the reference element, the images of the series of images overlapping in pairs, and
b. the determination, by means of the odometric goniometer or the odometric compass, an orientation of the reference element relative to the optronic system as a function of the acquired series of images of the scene;
the method comprises a phase for determining the position of an object in the scene as a function of the determined position of the optronic system, an obtained orientation of the object relative to the optronic system and an obtained distance between the object and the optronic system;
the object position determination phase comprises the steps of:
   acquisition of a series of images of the scene, the series of images comprising at least one image of the object, the images of the series of images overlapping in pairs, and
   determination of the orientation of the object relative to the optronic system as a function of the series of images of the scene;
the measurement module of the optronic system comprises at least one compass, the orientation of the object being obtained by a measurement acquired by the compass when the object is pointed by the digital imager;
at least one element of the optronic system measurement module is a telemeter, the distance between the object and the optronic system being obtained by a measurement acquired by the telemeter when the object is pointed by the digital imager, or
the distance between the object and the optronic system is the distance between the determined position of the optronic system and the intersection of a predetermined straight line with the ground of a digital terrain model, the predetermined straight line passing through the determined position of the optronic system and having as its orientation the obtained orientation of the object relative to the optronic system;
the optronic system is selected from among a pair of optronic binoculars and an optronic camera;
at least one element of the measurement module is a magnetic compass, the method comprising a phase of automatic calibration of the declination, measurements and boresighting of the magnetic compass by means of measurements acquired for at least two reference elements, during the pointing of said reference elements by the digital imager;
   the measurement module comprises a telemeter and a goniometer, the determination of the approach position of the optronic system comprising the automatic calibration of the bearing of the goniometer so that the goniometer functions as a compass, by means of measurements acquired with two reference elements, during the pointing of said reference elements by the digital imager.
   the measurement module comprises a telemeter and an inclinometer, the determination of the approach position of the optronic system being carried out by means of the measurements acquired for three reference elements, during the pointing of said reference elements by the digital imager.
   the measurement module comprises a goniometer, the determination of the approximate position of the optronic system, as well as a determination of the bearing of the goniometer being carried out by means of measurements acquired for three reference elements, during the pointing of said reference elements by the digital imager.

The invention further relates to an optronic system for determining at least one position by an optronic system in a scene, the scene comprising reference elements of known geographic coordinates, the optronic system comprising the following elements integrated into said optronic system:
a digital imager,
a memory in which is stored, for at least each reference element of the scene, an indicator representative of said point associated with the geographic coordinates of said point,
an element for displaying the indicators stored in the memory,
a measurement module comprising at least one element chosen from among: a compass, a goniometer and a telemeter,
a calculation unit,
the optronic system being configured to implement a method as described above.

Further features and advantages of the invention will become apparent from the following description of the embodiments of the invention, given by way of example only, and with reference to the drawings which are:

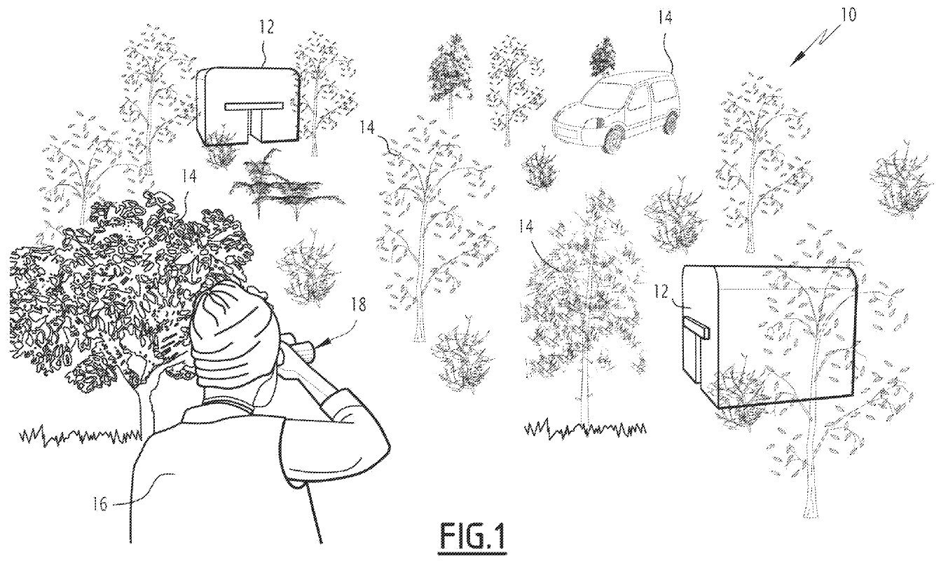

FIG. 1, a schematic representation of a scene comprising reference elements (landmarks), as well as objects of unknown coordinates; an operator equipped with an optronic system is also present in the scene,

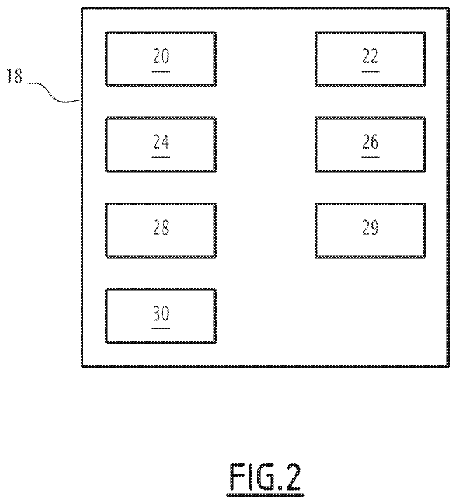

FIG. 2, a schematic representation of an example of an optronic system comprising elements integrated into said system,

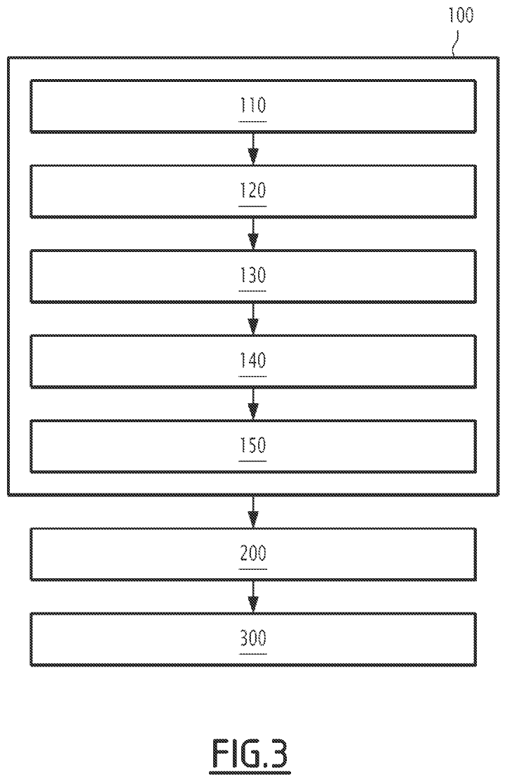

FIG. 3, a flowchart of an example of an implementation of a method for determining positions in a scene,

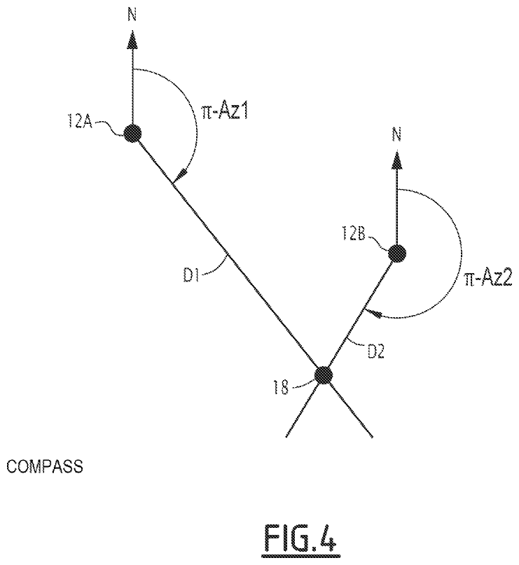

FIG. 4, a schematic representation of a first example of determining the position of the optronic system

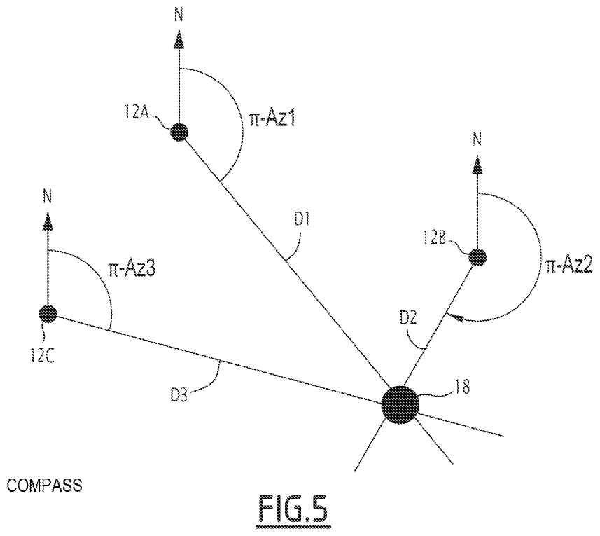

FIG. 5, a schematic representation of one alternative of the first example shown in FIG. 4,

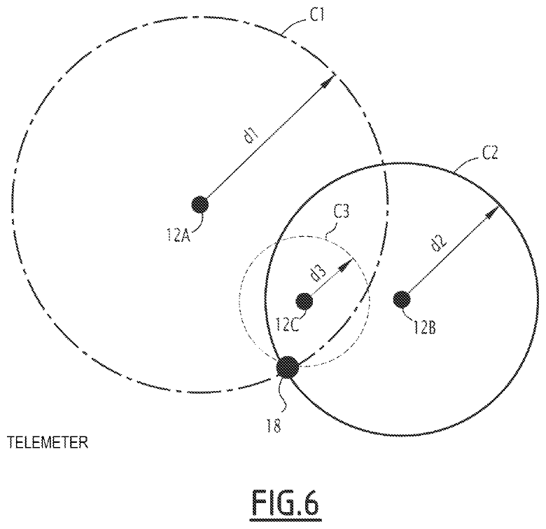

FIG. 6, a schematic representation of a second example of determining the position of the optronic system, and

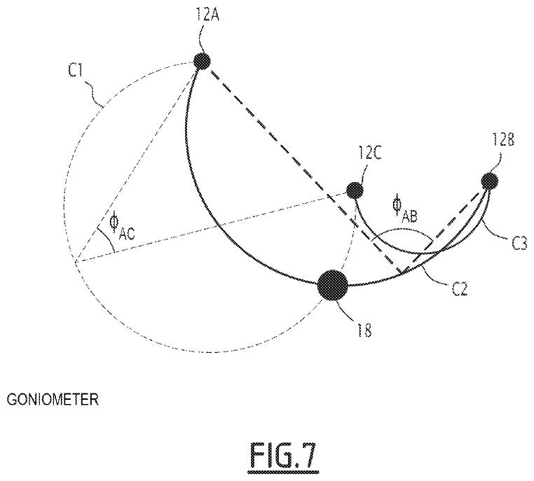

FIG. 7, a schematic representation of a third example of determining the position of the optronic system.

In the following description, an absolute orientation is characterized by angles expressed relative to a geographic reference. The most used are the azimuth angle, which expresses orientation in a locally horizontal plane (tangent to the ellipsoid associated with the geoid) relative to the local geographic meridian, and the elevation angle (or inclination angle), which expresses the orientation in a vertical plane, relative to the locally horizontal plane. A compass typically allows to measure an azimuth. An inclinometer typically allows to measure an elevation.

A relative orientation is defined relative to another orientation (in other words, an angular deviation between two orientations), characterized by the bearing angles in the horizontal plane and the elevation angles in the vertical plane. A goniometer typically allows to measure a bearing and an elevation.

A scene 10 is illustrated by way of example in FIG. 1. A scene refers to a theater of operations, in other words, the place where an action takes place. The scene is therefore an extended space with sufficient dimensions to allow an action to take place. The scene is typically an outdoor space.

The scene 10 comprises reference elements 12, also known as landmarks or reference structures, having known geographic coordinates. The scene 10 also comprises elements having unknown coordinates, also known as objects 14.

To implement the method according to the invention, an operator 16 equipped with an optronic system 18 is located in the scene 10. The optronic system 18 is therefore also an object 14 in the scene 10.

Each reference element 12 is a remarkable, fixed object in the scene 10. The coordinates (latitude, longitude) of each reference element 12 are known. Optionally, the altitude of each reference element 12 is also known.

The reference elements 12 are, for example, points belonging to the following elements: a construction (building, bell tower, lighthouse, road, bridge, etc.) and a natural element (mountain, rock, hilltop, vegetation, tree, etc.). In the example shown in FIG. 1, the reference elements 12 are buildings.

Every other element in the scene 10 different to a landmark is an object 14 of unknown position. In the example shown in FIG. 1, the objects 14 are trees, a vehicle as well as the optronic system 18 itself. The skilled person will understand that the term “object” is used in a broad sense, and also comprises individuals present in the scene.

The optronic system 18 is, for example, a system of:
portable optronic binoculars (with digital imaging, in any spectral band), mounted on a tripod or integrated into a turret or held in the hand, or
an optronic camera (with digital imaging, in any spectral band) mounted on a vehicle or other support (mast, tripod, turret, building, etc.), adjustable (controllable line of sight), or
an omnidirectional optronic camera mounted on a vehicle or other fixed support (mast, building, etc.), or
a system of distributed optronic cameras, installed on a vehicle or any other fixed support.

The optronic system 18 comprises elements integrated into said optronic system 18. By the term “integrated”, it is understood that the elements are physically incorporated with built-in software into said optronic system 18. Such elements therefore form a single block in the optronic system 18.

The optronic system 18 is thus advantageously compact and lightweight (preferably less than three kilos).

The elements integrated into the optronic system 18 comprise at least the following elements: a digital imager 20, a memory 22, a display element 24, a measurement module 26 and a calculation unit 28. Optionally, the optronic system 18 also comprises one of the following additional elements: a GNSS receiver 29 and an inclinometer 30.

The digital imager 20 is designed to acquire images of the scene 10. Advantageously, the digital imager 20 is able to operate in several spectral bands, for example, in the visible and infrared.

The digital imager 20 is, for example, a camera.

Data is stored in the memory 22. The data comprises, for at least each reference point 12 of the scene 10, an indicator representative of said reference element 12 associated with the geographic coordinates of said element 12. The indicators are typically visual elements that can be displayed on the display element 24 and allow the corresponding reference elements 12 to be identified.

The indicators are, for example, symbols, textual data (name of reference element 12) or geographic data, also known as geographic products. The geographic products comprise one or a plurality of the following elements: a cartography, an orthoimagery (of satellite or airborne origin), a digital terrain model (DTM) and a digital elevation model (DEM). In particular, the DTM is an internal datum allowing to retrieve the altitude of a point with known latitude and longitude coordinates, or to measure a distance by ray tracing.

In the case where the indicators are geographic products, the optronic system 18 also comprises a geographic information system (GIS) which groups together these products (the data) and the software(s) allowing them to be used (visualized, manipulated, etc.). Advantageously, the geographic information system integrates functionalities allowing the display to be modified, for example, to:
center a displayed image on a position (using an actuator, such as a button, joystick, mouse pointer, stylus, touch pad, eye tracker, etc.),
change the zoom of data display (increase or decrease zoom) by any means (mouse wheel, tactile pressure, joystick/buttons, eye tracker, etc.),
automatically reload data in case the center of the geographic product (map, orthoimage, etc.) or the display zoom is modified,
point an element on the map to obtain its geographic coordinates (using an actuator), or
display thematic layers of the geographic product (overlay) containing different types of information (for example, terrain intervisibility calculated from the observation post).

The geographic coordinates of reference elements 12 are, for example, in the form of metadata associated with said reference elements 12. The geographic coordinates are, for example, expressed by latitude data, longitude data and optionally altitude data (supplied by the digital terrain model, for example). Accuracy errors associated with these data are also provided.

In one example, only the indicators of reference elements 12 are stored in the memory 22, all the indicators therefore forming a reference book.

Such a reference book can be completed by the operator 16, for example, during a mission preparation phase. This mission preparation phase can be carried out:
either directly with the optronic system, which allows references to be created and their coordinates to be entered,
or via an external mission preparation system. In this case, the optronic system has the means to import data (USB key, Wi-Fi, etc.).

In this way, the skilled operator will understand that the references are either predefined (in mission preparation), or elaborated in situ, by selecting them on the GIS or by directly entering their coordinates.

For example, the positions of the reference element 12 are recorded by the operator 16 on a geographic product such as defined above and stored in the form of a list (reference book) in memory 22.

In another example, the indicators stored in memory 22 are geo-referenced points in the geographic information system, which provides latitude, longitude (and altitude data if the digital terrain model is carried on board, for example).

Preferably, memory 22 comprises, in addition to the indicators for the reference elements 12, the indicators for all geo-referenced points on stored geographic products. In other words, geo-referenced data (such as an ortho image or a map) is data in which each element (pixel, feature) is associated with geographic coordinates. Thus, each element of a geographic product is a visual indicator representing a point on the scene 10. This allows the operator to find the visual indicator of the pointed reference element 12 more easily by viewing it in an environment with similarities to the observed scene.

The display element 24 is able to display images from the digital imager 20 and/or data stored in the memory 22, such as indicators of the reference elements 12.

The display element 24 is, for example, a display, such as an OLED screen.

The measurement module 26 is able to take measurements relative to the reference elements 12 or the objects 14 in the scene 10.

The measurement module 26 comprises at least one element, such as a sensor, chosen from among: a compass, a goniometer and a telemeter.

The compass is, for example, a magnetic compass or an odometric compass.

The term “odometric compass” is taken to mean a software tool capable of measuring absolute orientations indirectly from images acquired of the scene 10. Thus, when the compass is an odometric compass, a calculation program relating to the odometric compass is, for example, able to be executed by the calculation unit 28. In this case, the odometric compass is able to implement an orientation measurement method such as that described in application FR 3 034 553 A, and which will be described in greater detail later in the description.

The goniometer is, for example, a physical goniometer or an odometric goniometer.

In a manner similar to the odometric compass, the term “odometric goniometer” is taken to mean a software tool able to carry out measurements of relative orientations indirectly from the acquired images of the scene 10. When the goniometer is an odometric goniometer, a calculation program relating to the odometric goniometer is, for example, able to be executed by the calculation unit 28. In this case, the odometric goniometer is able to implement an orientation measurement method such as that described in application FR 3 034 553 A, and which will be described in greater detail later in the description.

The telemeter is, for example, a laser telemeter.

The calculation unit 28 is able to receive data from the other elements integrated into the optronic system 18, in particular images from the imager 20, data stored in the memory 22 and measurements made by the measurement module 26.

The calculation unit 28 is, for example, a processor.

In one example, the calculation unit 28 interacts with a computer program product that includes an information medium. The information medium is a medium readable by the calculation unit 28.

The readable information medium is a medium suitable for storing electronic instructions and able to be coupled to a computer system bus. For example, a floppy disk, an optical disk, a CD-ROM, a magneto-optical disk, a ROM, a RAM, an EPROM, an EEPROM, a magnetic card, an optical card or a USB key. The data medium stores the computer program product comprising program instructions.

The computer program can be loaded into the calculation unit 28 and, leads to the implementation of a method for determining positions in a scene 10 when the computer program is implemented on the calculation unit 28 as will be described in the rest of the description.

The operation of the optronic system 18 resulting in the implementation of a method for determining positions in a scene 10 will now be described with reference to the flowchart in FIG. 3. The determination method is implemented only by the elements integrated in the optronic system 18.

During implementation of the method, the optronic system 18 and the objects 14, the positions of which are to be determined are stationary.

### DATA COLLECTION (PHASE 100)

The determination method comprises a phase 100 for collecting data relative to at least one reference point 12 in the scene 10. The data collected relates to the reference elements 12 visible from the optronic system 18 (within range and not masked). The collection phase 100 comprises, for each reference element 12 considered, the following steps.

### Pointing the Reference Element(s) (Step 110)

The collection phase 100 comprises a pointing step 110, by the digital imager 20, of the reference element 12 in the scene 10. By the term “pointing” in relation to the digital imager 20, it means the alignment of a reference, such as a reticle, of the digital imager 20 on the reference element 12 in the target scene 10.

### Measurement Acquisition for Each Pointed Reference Element (Step 120)

The collection phase 100 then comprises an acquisition step 120, by the measurement module 26, of at least one measurement relative to the reference element 12 pointed in the scene 10, following reception of a first acquisition command. The first acquisition command is a validation carried out by the operator 16 of the optronic system 18, for example, via an actuator. The actuator is; for example, a button, a joystick, a mouse pointer, a stylus, a tactile support, an eye tracker, etc.

A measurement carried out by the compass allows an azimuth angle to be obtained for the reference element 12. A measurement carried out by the goniometer allows an elevation and bearing angle to be obtained for the reference element 12, relative to another reference element 12. A measurement carried out by the telemeter typically allows a distance to be obtained for the reference element 12.

As an optional addition, during the measurement acquisition step, by the measurement module 26, when the optronic system 18 comprises an inclinometer 30, a measurement of the elevation of the reference element pointed in the scene 10 is also obtained.

In one embodiment where the measurement module 26 comprises an odometric goniometer or an odometric compass, at least one acquired measurement relative to the reference elements 12 is an orientation measurement. In this case, the acquisition step 120 comprises:
acquiring a series of images of the scene 10, the series of images comprising at least one image of the reference element 12, the images in the series overlapping in pairs, and
determining, by the odometric goniometer or odometric compass, of the orientation of the reference element 12 relative to the optronic system 18 as a function of the series of images of the scene 10 acquired.

Advantageously, the series of images acquired allows:
changing the field of view to zoom in on the target: in the series of images, the camera field of view is modified with each image (continuous zoom), so that for the narrow field of view, the target or reference is imaged and pointed with maximum precision, and furthermore, one image in the series has the field of view used during the calibration phase (generally a wide field of view). The intermediate images are used to align the images relative to each other from one to the next.
acquiring a target or reference outside the calibration scene: if the object pointed is outside the scene established during calibration, the series of images allow, by moving the camera while the image series is being acquired, to create an “image bridge” linking the target to the scene.
both at the same time (zooming the target and pointing a target outside the calibration scene)

In an example of the use of the odometric goniometer/compass, it should be noted that the position of the observer comes into play in two cases:
for the absolute orientation of the calibration scene, in order to calibrate the odometric compass using at least one absolute orientation as a reference (not done for the odometric goniometer, which is relative).
for fine calibration of the goniometer when calibration has not been performed over 360° (in the case of calibration over a sector<360°, two reference orientations are required to re-estimate the focal length).
   However, fine calibration is not initially required, as an approximate focal length is available. In practice, the method is iterative: approximate calibration->approximate position->fine calibration->fine position->fine calibration->fine position, and so on.

Consequently, when the position of the observer is unknown (GNSS absent or non-functional), and the operator wishes to use the odometric goniometer/compass (because it is more accurate than other means):
the odometric compass cannot be used as a first choice.
the odometric goniometer is first used (without any prior knowledge of the position of the observer) to take relative orientations on references, which allows to determine the position of the observer, thus allowing to initialize the compass (which can then be used, in particular, to locate objects).

This process requires the use of at least 2 references in the scene.

More precisely, the orientation of the reference element 12 is obtained by implementing an orientation measurement method such as that described in application FR 3 034 553 A.

More precisely, as described in application FR 3 034 553 A, according to this example, the method comprises a learning phase and an operational phase. The learning phase comprises the following steps:
acquisition, by circular scanning using the optronic system 18, of a series of partially superimposed optronic images, including one or more images of the scene 10 (step A1),
automatic extraction from the images of descriptors defined by their image coordinates and radiometric characteristics, with at least one descriptor of unknown orientation in each image overlap (step B1),
from the descriptors extracted from the overlaps between images, automatic estimation of the relative rotation of the images and mapping of the descriptors extracted from the overlaps (step C1),
identification in the images of at least one known geographic reference direction with an accuracy compatible with the desired performance, and determination of the image coordinates of each reference (step D1),
on the basis of the descriptors extracted from the overlays and mapped, the direction and the image coordinates of each reference, automatic estimation of the attitude of each image, the so-called fine tuning step (step E1), and
from the attitude of each image, the position and internal parameters of the first imaging device, and the image coordinates of each descriptor, calculation of the absolute directions of the descriptors according to a predetermined image capture model of the imaging device (step F1).

The operating phase comprises the following steps:
acquisition of at least one image of the object, in this case the pointed reference element 12, known as the current image, from the optronic system 18 (step A2),
extraction of the descriptors from each current image (step B2),
mapping of the descriptors of each current image with the descriptors the absolute direction of which was calculated during the learning phase, so as to determine the absolute direction of the descriptors of each current image (step C2),
from the absolute directions of the descriptors of each current image, estimation of the attitude of each current image (step D2),
from the image coordinates of the reference element 12 in each current image, from the attitude of each current image, from the position and from predetermined internal parameters of the optronic system 18, calculation of the absolute direction of the pointed reference element 12, according to a predetermined image capture model of each current image (step E2).

Optionally, once the reference element 12, pointed and measured, a fine pointing step is possible, consisting of aligning an alidade on a precise point of an image (from among the series of acquired images) of the measured reference. This step allows to fine-tune precisely the point on the reference element 12 that corresponds to the geographic coordinates of the reference designated in step 130.

### Pointing an Indicator for Each Pointed Reference Element (Step 130)

The collection phase 100 comprises a pointing step 130, on the display element 24, from among the indicators stored in memory 22, of an indicator representative of the reference element 12 pointed in the scene 10. During this step, the pointing refers to the alignment of a reference (digital pointer, stylus) on the indicator of the reference element 12 or the selection of the reference element 12 from among a list (reference book).

In one example of implementation, the pointing step 130 comprises displaying on the display element 24, in parallel, or successively, or superimposed:
a. the image of the scene 10 comprising the reference element 12 pointed by the digital imager 20, and
b. indicators stored in the memory 22.

For example, when the display is made in parallel, one part of the display element 24 displays the image of the scene 10, and another part displays the indicators.

For example, when the display is made successively, the image of the scene 10 on the one hand, and the indicators on the other hand, are likely to be displayed on the entire display element 24.

For example, when the display is superimposed, the indicators of the reference elements 12 are displayed superimposed (approximately) on the image of the scene (by projection into the space of the scene).

### Acquisition of Geographic Coordinates Associated with Each Pointed Indicator (Step 140)

The collection phase 100 then comprises an acquisition step 140, by the calculation unit 28, of the geographic coordinates associated with the pointed indicator, following reception of a second acquisition command. The second acquisition command is a validation performed by the operator 16 of the optronic system 18, for example, via an actuator.

The person skilled in the art will understand that the order of steps 110 to 140 is given by way of example, steps 110-120 being interchangeable with steps 130-140 (it is possible to start by designating reference data, then to make measurements on the corresponding object in the scene. Or vice versa).

### Storing Reference Data (Step 150)

The collection phase 100 then comprises a step 150 for storing data, called reference data, comprising the at least one acquired measurement and the acquired geographic coordinates. Thus, in the memory 22, the known geographical positions of the pointed reference elements 12 are associated with the measurements obtained for said reference elements 12 via the measurement module 26.

### DETERMINING THE POSITION OF THE OPTRONIC SYSTEM (PHASE 200)

The method comprises a phase 200 for determining the position of the optronic system 18 as a function of stored reference data for the at least one reference element 12. The determination phase 200 is implemented by the calculation unit 28.

Advantageously, the determination phase 200 comprises the determination of an uncertainty on the determined position of the optronic system 18 by exploiting uncertainties on the at least one element having acquired the measurements and on the stored geographic coordinates of the reference elements 12.

In one embodiment, the determination phase 200 comprises the selection, by the calculation unit 28, of at least one position determination technique from among a set of position determination techniques as a function of the nature of the element or elements of the measurement module 26 having acquired the at least one measurement corresponding to the reference data. Advantageously, the selection is realized automatically by the calculation unit 28. The position of the optronic system 18 is then determined on the basis of the or each selected determination technique.

When the measurements have been acquired by elements of a different nature, the calculation unit 28 may select several different determination techniques. The results obtained following the implementation of these techniques are, for example, compared, averaged or weighted to obtain an optimized position (in terms of precision) for the optronic system 18.

In one implementation mode, the position is obtained according to the following schematic:
A) Calculate an approximate position with a minimum of measurements/observations. This approximate position solution is obtained explicitly. The number of observation equations is identical to the number of parameters to be estimated (at least two for estimating a position limited to the horizontal plane).
B) Estimate an optimal position by minimizing a distance metric. The metric is typically written as the quadratic sum of the distances from the position to the locations corresponding to the observations, each weighted according to the errors in the instrument measurements and in the reference coordinates. The estimator used delivers a position and its covariance with the set of available observations. We can use:
a batch approach, iteratively minimizing the metric starting from the approximate position. This estimator makes advantageous use of the a priori information carried by the approximate position and its covariance by adding two or three equations, according to the dimension of the space in which the position is calculated.
a sequential Kalman filter approach, updated by incrementally aggregating the various measurements.
C) Estimate a position having integrity. To eliminate biased observations that may have contributed to the estimation in the previous step. This step having as object to:
   Detect whether at least one of the observations is an outlier,
   If so, identify which observation(s) is/are outliers,
   If identified, exclude the outlier(s) from the observation batch to feed an estimator as in the previous step.
D) Calculate a definitive position (if GNSS present). This step finalizes the position calculation as follows:
   a. Evaluation of the state of the GNSS receiver, from the position it delivers and the uncertainty it associates with it, with respect to the position having integrity obtained and its covariance.
   b. If the GNSS state is judged to be correct, calculate the definitive position by merging the position having integrity with the GNSS position according to their respective covariance, and calculate the covariance of the definitive position.

In particular, for A), the elaboration of an approximate solution is guided:
According to whether or not a magnetic compass (DMC), laser range finder (LRF) or goniometer (GON) is accessible, thus allowing adaptation to the optronic system architecture,
According to the number of landmarks available, which allows to decide on the type of approximate solution to be used, so as to have an approximate solution as soon as possible as the number of landmarks available increases.

A solution is described by the number and nature of the estimated parameters. These can be:
The planimetric and/or altimetric position of the optronic system. Reference point at the optical center of the digital imager 20,
Bearing or attitude of the goniometer,
Magnetic compass calibration, which can itself be modeled at three levels, summarized here:
   Estimation of azimuth bias, incorporating compass bias, error on or ignorance of local magnetic declination, error or ignorance of horizontal component of boresighting.
   Estimation of an azimuth correction model incorporating bias, and periodic components modeling the Hard and Soft Iron effects.
   Estimation of a corrective model adding to the previous parameters two angles of rotation characterizing the boresight attitude.

Some cases used to implement the method are described. To obtain an approximate solution, the barycentric local geographic reference frame of the landmark(s) is initially used. The angular directions are corrected accordingly in azimuth for the transition between plane and spherical geometry, and in elevation (taking into account the effects of atmospheric refraction if precision is required, and according to the availability of meteorological data):
With magnetic compass and inclinometer
   Input
      Measurement of the geodetic coordinates of two distinct landmarks, and the associated Cartesian errors (planimetric and altimetric),
      Two magnetic azimuth measurements (magnetometer and declination) and associated errors on the landmarks,
      At least one elevation measurement (inclinometer) and its error on the landmarks.
   Implementation
      Approach 1: a position is estimated by triangulation as the location minimizing the quadratic sum to 2 lines in space.
      Approach 2: the intersection of lines in the plane supported by each landmark is calculated, adding π to each of the two azimuth measurements. The vertical position is then calculated from the elevations on the landmarks and the planimetric position obtained.
      In each approach, a covariance is calculated on the position obtained, depending on the errors on the 2 landmarks and the errors of the angular measurements.
      Calculation of the geodetic position of the system using the Cartesian solution in barycentric reference frame.
   Output
      Approximate geodetic position of the optronic system P_{c}
      Covariance on the position, 3×3 matrix described in Local Geographic Landmarks (LGL) Λ_{C}
With telemeter and inclinometer,
   Input:
      Measurement of geodetic coordinates of three distinct landmarks, and the associated Cartesian (planimetric and altimetric) errors,
      Three elevation measurements on the landmarks.
      Three distance measurements on the landmarks.
   Implementation
      Calculate the radius obtained by rectifying the distance and elevation measurements.
      In barycentric reference frame, intersection of 3 circles centered on each landmark by estimating the plane position in the LGL by solving a redundant linear system (Degrees Of Freedom: DoF=1)
      Estimation of the vertical position of the system using distances and elevations
      Calculation of the geodetic position of the system
   Output
      Approximate geodetic position of optronic system P_{T}
      Covariance on the position, 3×3 matrix described in LGL Λ_{T}
   With goniometer,
   Input
      Measurement of the geodetic coordinates of three distinct landmarks, and the associated Cartesian errors (planimetric and altimetric),
      Three goniometer measurements on the landmarks (azimuth and elevation) and associated errors.
   Implementation
      Approach 1: by eliminating the bearing in the barycentric reference frame:
      Intersection of 3 circles is possible by difference of angular azimuth readings of the goniometer on the 3 landmarks.
      Estimation of position as above with LRF, replacing the inclinometer readings by the goniometer readings.
      Estimation of the bearing on the 3 landmarks based on the flat position obtained.
      Approach 2: By calculating the bearing in the barycentric reference frame.
   Explicit bearing calculation
   Intersection of 3 straight lines to estimate the plane position obtained by solving a linear system of 3 equations.
   Output
   Approximate geodetic position of the optronic system P_{G}
   Covariance on the position, 3×3 matrix described in GLR κ_{G}
   Approximate bearing of the goniometer G₀
   Standard deviation of goniometer bearing σ_{G}_{₀}.
   With telemeter and goniometer,
   Input:
      Measurement of the geodetic coordinates of two distinct landmarks, and the associated Cartesian errors (planimetric and altimetric),
      Two elevation measurements on the landmarks.
      Two distance measurements on the landmarks.
      Two goniometer readings, or angular deviation, on the 2 landmarks.
   Implementation
      Calculate the barycenter of the 2 landmarks and the coordinates of the landmarks in the geographical reference frame from which the barycenter originates.
      Calculate the 2 radii obtained by rectifying the distance and elevation measurements in the plane.
      Calculate the characteristics of the goniometric circle passing through the 2 projected landmarks.
      In the barycentric reference frame, intersection of the 3 previous circles in the GLR by solving a redundant linear system (DoF=1).
      Estimation of the vertical position of the system using the distances and the elevations.
      Calculation of the geodetic position of the system
      To refine the solution with respect to the correct use of elevations and azimuths, taking into account the roundness of the Earth; estimation of the position and bearing of the goniometer using the previous approximate solution.
   Output
      Approximate geodetic position of the optronic system P_{GT}
      Covariance on the goniometer position and the bearing, 3×3 matrix described in GLR Λ_{GT}

In another example, at least one reference point 12 is considered, and the measurement module 26 comprises a magnetic compass and a telemeter. The magnetic compass allows to measure the angle relative to north at which the optronic system 18 views the reference element 12, and to draw an associated straight line. The telemeter allows to determine the distance between the optronic system 18 and the reference element 12. This distance is plotted on the straight line, which allows the position of the optronic system 18 to be deduced.

As far as B is concerned, the search for an optimum position allows an improved localization performance to be obtained. This takes place as soon as there are:
an overabundant number of single-mode landmarks,
a minimal number of multi-modality landmarks,
an overabundant number of landmarks and mixed modalities.

As far as C is concerned, the search for a solution having integrity is carried out as soon as possible, and the search for an approximate solution, such as presented, allows to separately assess a level of measurement integrity, right from the approximate position calculation stage, in other words, without strong redundancy. To do this, we confront 3 situations taking positions by pairs of 2 modalities (α, β)∈{C, T, G} and perform a comparison test of their mean. In summary, the difference between the 2 positions is compatible with their covariance, with a threshold τ, set according to the desired probability of coherence. If ℑ_{α,β}≤τ then the 2 positions obtained from the α and β modalities are coherent.

Thus:
if ℑ_{C,G} is coherent but neither ℑ_{C,T} nor ℑ_{G,T} is, then a telemetry problem on a landmark may be suspected.
if ℑ_{G,T} is coherent but neither ℑ_{C,T} nor ℑ_{C,G} are, then a problem with the magnetic compass may be suspected.

This integrity characterization is considered minimal in terms of integrity control, as it does not allow an error in the coordinates of a landmark to be detected. To achieve this, we use a multi-layered method:
information redundancy, where all the landmarks are used in single or intra-modality,
multi-modality redundancy, comparing inter-modality solutions obtained separately with a minimum number of landmarks, for example, solutions for all the possible modalities on 3 landmarks.
information redundancy using a global test with all the landmarks in all the modalities feeding the same estimator.
A distinct batch and sequential Bayesian estimator redundancy to integrate the approximate solution information, producing a solution and its estimated covariance, and a comparison test of their respective estimates.

As far as D is concerned, once the optimal position and its covariance have been estimated, the position and covariance of the GNSS receiver are tested in order to:
evaluate its status and inform the user,
merge the estimated position with the GNSS position if this latter is deemed credible.

This allows a final position of ultimate performance to be obtained.

More specifically, to evaluate the status of the GNSS receiver, the following procedure is used:
After estimating a position P₂₆, having integrity, at the end of the previous steps and calculating its covariance Λ₂₆ with the set of correct measurements on the available reference elements 12,
After receiving the position P₂₉ and its covariance Λ₂₉ from GNSS through the National Marine Electronics Association (NMEA) standard messages,
A coherence test is carried out between the 2 previous distributions, and between the NMEA information and those of the GNSS receiver data sheet. The GNSS receiver is judged to be inoperative in the event of incoherence and, conversely, operative in the event of coherence. In the latter case, the definitive position P₁₈ of the optronic system 18 is obtained as follows

Λ₁₈⁻¹P₁₈=Λ₂₆⁻¹P₂₆+Λ₂₉⁻¹P₂₉

Expression in which the covariance on the definitive position is given by: Λ₁₈⁻¹=Λ₂₆⁻¹+Λ₂₉⁻¹.

In summary of D, when the optronic system 18 comprises a GNSS receiver 29, the phase of determining the position of the optronic system 18 comprises determining the position of the optronic system 18 by the GNSS receiver 29, the so-called GNSS position, and validating or not the GNSS position by comparison with a position previously obtained for the optronic system 18 via the reference data (preferably the position having integrity). This in particular allows to check that the GNSS receiver has not been jammed or decoyed. When the GNSS position has been validated, a definitive position for the optronic system 18 is obtained by merging the GNSS position with the last position obtained for the optronic system 18 via the reference data (preferably the position having integrity).

In conclusion, in this example of implementation, three levels of verification are proposed for the integrity of the solution:
In mono-modality and with an overabundant number of landmarks, methods similar to the GNSS Receiver Autonomous Integrity Monitoring (RAIM) techniques are used. The originality here lies in the fact that we work with various types of information (landmark coordinates+a type of angle or distance measurement, according to the modality) and that the coherence of all the estimated parameters is evaluated, not necessarily limited to position alone.
In mixed modality, the originality comes from working in conjunction with several types of measurement.
In multi-estimator mode, on the same perimeter of information, batch and sequential in parallel.

In the following, are given examples illustrating the principles described above, with particular reference to FIGS. 4 to 7.

For the sake of simplicity, it is to be noted, the following examples are given for two-dimensional positioning (projection in the horizontal plane). In this case, the vertical component (altitude, elevation) is not considered, and the problem as a whole is projected in a horizontal mean plane. The positions are then described by two parameters (planimetric position) and angular orientations (of landmarks or the observed) are described by the azimuth or bearing value alone. The measured distances can be used as they are, or preferably projected in the horizontal plane using the cosine of the elevation of the lines of sight, if known.

The simplifying 2D assumption is sufficient (in terms of accuracy versus need) in several cases characterized by:
little relief (small difference in altitudes in the theater of operation),
knowledge of altitudes (observer, observed) not required or not needing to be precise,
observation geometry (line of sight between observer and landmarks and observed) close to horizontal (<10°).

The calculations carried out to obtain the position can nevertheless be adapted to a 3D or 2D approach, according to requirements. In particular, given a 2D planimetric position (longitude and latitude), obtained by using a plane local to the sensor position, and accessing a geographic product of the DTM/DEM type, the vertical component of the position is completed by interpolation in the DTM/DEM. In the event a DEM is not available, and the position is located on an above-ground structure (for example, a building), then the height of the structure, if needed, is calculated by a specific measurement with the digital imager 20.

For each reference element 12, depending on the nature of the element(s) of the measurement module 26, the following measurements can be obtained and used to determine the position of the optronic system 18:
absolute geographic orientation, measured by a compass,
the angular deviation relative to another reference element 12, measured by a goniometer, and
the distance to the optronic system 18, measured by a telemeter.

For each reference element 12, depending on the active elements of the measurement module, there are therefore 7 possible sets of usable measurements (1 observation from among 3, or 2 observations from among 3, or all 3 observations) according to the observations (measurements) available/carried out.

The principles of four techniques for determining the position of the optronic system 18 are given by way of example in the following, depending on the information available and/or used on each reference element 12:
first technique: use of absolute angles measured by a compass (see FIG. 4 (2 landmarks) and FIG. 5 (3 landmarks)),
second technique: using distances measured by telemetry (see FIG. 6),
third technique: using angular deviations measured by a goniometer (see FIG. 7), and

fourth technique: using measurements from sensors of different kinds, the fourth technique is based on a combination or fusion of one or more previous techniques.

In one example, according to the first technique, only absolute angular orientations of the landmarks, measured from the observation position (unknown, also known as the position of optronic system 18), are used. The first technique involves measurements taken on at least two reference elements 12.

As illustrated in FIG. 4, for two reference elements 12A, 12B, the position of the optronic system 18 is located at the intersection of half-lines D1 and D2. Each half-line D1, D2 has as its origin a reference element 12A, 12B (the origin corresponds to the geographic coordinates acquired for reference element 12) and has as its direction the angular orientation (signed) measured by the magnetic compass. The references Az1 and Az2 designate the respective azimuths of the reference elements 12A and 12B. The reference N designates north.

When the number of reference elements is greater than or equal to three, as illustrated in FIG. 5 for the three reference elements 12A, 12B, 12C, the intersection of the half-lines D1, D2, D3 is not made at a single point (taking into account errors on the angles, and on the position of the reference elements). The position chosen is, for example, the result of an optimization of non-linear equations resulting from a problem describing the geometry of the example.

In another example, according to the second technique, only the distances of the reference elements 12, measured from the position of the optronic system 18, are used. In this example, the measurements are carried out on at least three reference elements 12.

As shown in FIG. 6, the position of the optronic system 18 is located at the intersection of circles C1, C2, C3. Each circle C1, C2, C3 is centered on a reference element 12A, 12B, 12C and has as its radius the distance d1, d2, d3 measured for the reference element 12A, 12B, 12C. The circles C1, C2, C3 do not intersect at a single point (due to errors in the distances and positions of the reference elements). The position chosen is, for example, the result of an optimization of non-linear equations resulting from a problem describing the geometry of the example.

In another example, according to the third technique, only the angular deviations between two reference elements 12 (pairs of reference elements), measured from the position of the optronic system 18, are used. In this example, measurements are carried out on at least two pairs of reference elements, that is, at least three reference elements 12.

As shown in FIG. 7, the position of the optronic system 18 is located at the intersection of the circular arcs C1, C2. Each circular arc C1, C2 passes through the two reference elements of a pair of reference elements, which form the ends of the circular arc, and its radius is such that each point of the circular arc C1, C2 is the vertex of an angle (signed) Φ_{AC}, Φ_{AB} equal to the angle measured between the two reference elements.

Starting with four reference elements (three arcs of a circle), the arcs of a circle do not intersect at a single point (given the errors in the angles, and in the position of the landmarks). The position chosen is, for example, the result of optimizing the non-linear equations resulting from a problem describing the geometry of the example.

In another example, according to the fourth technique, the position of the optronic system 18 is determined by exploiting the measurements from different elements of the measurement module 26, the measurements being available for each reference element considered, or the measurements (one per reference element) made by the different elements between the reference elements 12.

Generally speaking, in a simplified “2D” approach, determining the position of the optronic system 18 comes down to determining the intersection of several geometric locations:
half-lines passing through the reference elements 12, characterized by an absolute angle (half-lines derived from absolute orientation measurements of the reference elements 12), and/or
circles centered on reference elements 12 and having a radius equal to the measured distance from the reference element (circles derived from distance measurements of reference elements 12), and/or
arcs of circles passing through two reference elements 12, the radius and center coordinates of which are expressed as a function of the angular deviation measured between the two reference points and the coordinates of these two points.

The intersection of these geometrical figures is generally not concentrated in a single point, but forms an intersection zone, taking into account errors in the observations (errors in the angles, distances and positions of the reference elements 12).

Using measurements from the elements of different natures to determine the position of the optronic system 18 allows to:
reject the measurements that appear to be outliers in relation to the other measurements,
calculate a minimized intersection (center of the intersection zone) which is retained as the position of optronic system 18, and
evaluate the precision associated with this position, which expresses the size of the intersection zone, accentuated by taking into account the precision of each measurement (precision of angles, distances and positions).

### OBJECT POSITION DETERMINATION (PHASE 300)

The determination method comprises a phase 300 for determining the position of an object 14 (observed) in the scene 10 as a function of the determined position of the optronic system 18 (observer), of an absolute orientation obtained for the object 14 relative to the optronic system 18 and a distance obtained between the object 14 and the optronic system 18. The object 14 considered is visible from the optronic system 18 (within range and unmasked).

The position of object 14 is then obtained by calculating, by the calculation unit 28, the geographic coordinate located at the end of the vector having as origin the position of the optronic system 18, for orientation, the absolute orientation of object 14 and for length, the distance between the optronic system 18 and the object 14.

Advantageously, the accuracy of the position of the object 14 is calculated as a function of:
the accuracy of the position of the optronic system 18,
the absolute orientation accuracy of the object 14, and
the value of the distance and the accuracy of the distance between the optronic system 18 and the object 14.

For orientation determination, according to one example, when the measurement module 26 comprises at least one magnetic compass, the absolute orientation of the object 14 is obtained by a measurement acquired by the compass after pointing of the object 14 by the digital imager 20, after automatically taking into account the magnetic declination (integrated into the device).

According to another example, the orientation of the object 14 is obtained by implementing a measurement method (odometric compass) such as that described in application FR 3 034 553 A. Such a method comprises, in particular, acquiring a series of images of the scene 10, the series of images comprising at least one image of the object 14, the images overlapping two by two. Such a method also comprises determining the orientation of the object relative to the optronic system as a function of the series of images of the scene.

For determining the distance between the object 14 and the optronic system 18, according to one example, when at least one element of measurement module 26 is a telemeter, the distance between the object 14 and the optronic system 18 is obtained by a measurement acquired by the telemeter when the object 14 is pointed by the digital imager 20.

According to another example, when the object 14 is on the ground, the distance between the object 14 and the optronic system 18 is obtained by a ray-tracing method from a digital terrain model of the scene 10. The distance obtained is then the distance between the determined position of the optronic system 18 and the intersection of a predetermined straight line with the ground of a digital terrain model. The predetermined half-line passes through the determined position of the optronic system 18 and has the orientation obtained from the object 14 relative to the optronic system 18.

Thus, the position determination method allows to determine, on the one hand, the position of the optronic system 18 (observer) and, on the other hand, if desired, the position of an object 14 in the scene 10 of unknown coordinates (observed), by means of only the elements having integrity in an optronic system 18, provided that the scene 10 comprises at least one reference point 12 of known position (landmark).

Such a method eliminates the need for a GNSS receiver.

The data collection phase by means of only the elements integrated into the optronic system 18 is particularly ergonomic for the operator 16. In particular, the display element 24 allows to establish, in an easy manner, a correspondence between the reference element pointed in the scene 10 and the corresponding indicator stored in the memory 22 of the optronic system 18. This reduces the risk of error.

In addition, the fact that all the elements are integrated into the optronic system 18 allows the accuracy of the determined positions to be determined. Indeed, the accuracies of the elements of the measurement module 26, the geographic coordinates and the possible approximations in the calculations performed are all centralized by the calculation unit 28.

Depending on the case, the method also allows:
Checking the integrity (detection and rejection of measurement or data outliers), which allows errors to be reduced.
Simplified calibration of the magnetic compass, which saves time.
Ability to work without telemetry, in other words, passively (without emitting waves), which enhances discretion.
User assistance for landmark acquisition (as everything is integrated),which allows to save time and to obtain an improved performance.
User assistance in selecting the measurements to be carried out (as everything is integrated), which allows an improved performance.

The skilled person will understand that the previously described embodiments can be combined to form new embodiments provided that they are technically compatible. Furthermore, the embodiments described can also be supplemented by the additions described below.

### Calibration of A Magnetic Compass

As an optional addition, at least one element of the measurement module 26 is a magnetic compass, in which case the method comprises a magnetic compass calibration phase (self-calibration) as a function of measurements acquired after positioning of the optronic system (without GNSS) by means of:
ideally, at least two reference elements 12, although a single one could suffice with the telemeter, in order to achieve a position of correct quality of the optronic system with an uncalibrated magnetic compass. By “position of correct quality” of the optronic system is meant a quality equivalent to positioning with GNSS in standard mode.
a set of orientations obtained from attitude measurements of sector or panoramic images acquired during the calibration phase and estimated by the odometric compass, dated by the optronic system clock.
a set of orientations obtained from the measurements of orientation of the magnetic azimuth and the elevation of the magnetic compass, dated by the optronic system clock.
the time synchronization of the two previous sets of orientations.
A correction model for magnetic measurements, for example, able to implement one of the following methods.

A first method consists of estimating a simple azimuth bias by means of a measurement modality (telemeter or goniometer) that delivers a quality solution, including over a low number of landmarks. An example of a minimum configuration, with 2 landmarks measured by 2 telemeters and 2 magnetic compasses. Even when biased, the compass measurements are sufficient to determine the correct position solution from among the 2 intersections of the distance circles in the plane. The projection in the plane is carried out using the elevation measurements of the inclinometer, whether or not integrated with the magnetic compass. With the optronic system in the correct position, it is then easy to determine the bias of the magnetic compass. In practice, this bias takes into account the lack of knowledge of local declination, the mounting of the compass to the optronic system and the bias inherent in the magnetic azimuth measurement. With an overabundant number of measurements, the compass bias can be estimated.

A second method consists of solving only an azimuth correction model. The set of observations allows the coefficients to be estimated by solving a linear system; the transformation between the odometric ψ_{c} and magnetic ψₘ azimuth orientations is then written as a function of coefficients (αₖ, βₖ):

$${ψ}_{c} - {ψ}_{m} = Δ ψ = {{\sum }^{K}}_{k = 0} [ {α}_{k} \cdot sin ( k \cdot {ψ}_{m} ) + {β}_{k} \cdot cos ( k \cdot {ψ}_{m} ) ]$$

The magnetic azimuth can be compensated by an approximate value of the local magnetic declination to give the value ψₘ, the azimuth-independent coefficient β₀ will incorporate the least residual error of declination and mounting of the DMC with respect to the imaging even.

A set of M measurement pairs leads to M equations, the parameters of which are extracted as the least-squares solution of a linear system with A being a matrix M×(2K+1), and B a vector M×1. With a modeling of order K=2 incorporating ‘soft’ and ‘hard iron’ effects, the unknown coefficients β₀, α₁, β₁, α₂, β₂ are obtained with:

$$A ( \begin{matrix}{β}_{0} \\ {α}_{1} \\ {β}_{1} \\ {α}_{2} \\ {β}_{2}\end{matrix} ) = B$$

This method requires no special knowledge of magnetic declination. This is integrated into the first-order term β₀. To determine the attitude of an optronic system image from magnetic compass measurements (and integrated inclinometers/accelerometers) boresighting must first be carried out. This operation, which involves estimating the mounting angles between the sensitive axes of the compass relative to the axes of the reference track of the optronic system, does not have to be carried out every time the compass is used, as the mounting of the compass to the optronic system is rigid over time.

A third method estimates both the attitude of the magnetic compass and its boresight described by its attitude R_{V}^{M} in the camera. The transformation between the odometric V and magnetic M orientations is then written with the mounting default matrix R_{V}^{M}:

M=R_{V}^{M}·V

Or, equivalently, the inverse mounting correction matrix R_{M}^{V}:

V=R_{M}^{V}·M

Where:
Writing the rotation correction matrix as:

$${R}_{M}^{V} = {R}_{{ψ}_{s}} {R}_{{θ}_{s}} {R}_{{φ}_{s}} = ( \begin{matrix}cos {ψ}_{s} & - sin {ψ}_{s} & 0 \\ sin {ψ}_{s} & cos {ψ}_{s} & 0 \\ 0 & 0 & 1\end{matrix} ) ( \begin{matrix}cos {θ}_{s} & 0 & sin {θ}_{s} \\ 0 & 1 & 0 \\ - sin {θ}_{s} & 0 & cos {θ}_{s}\end{matrix} ) ( \begin{matrix}1 & 0 & 0 \\ 0 & cos {φ}_{s} & - sin {φ}_{s} \\ 0 & sin {φ}_{s} & cos {φ}_{s}\end{matrix} )$$

Writing a magnetic compass orientation M(ψ_{c}, θ_{c}), forgetting atmospheric refraction on its elevation θ_{c} as:

$$M = ( \begin{matrix}cos {θ}_{c} cos {ψ}_{c} \\ cos {θ}_{c} sin {ψ}_{c} \\ - sin {θ}_{c}\end{matrix} )$$

Recalling further:
that the boresighting angles ψₛ, θₛ and φₛ are small, or known to within a few degrees, because the compass axes are mounted roughly parallel to those of the imaging channels. This then allows them to be written (ψₛ, θₛ, φₛ)=(ψₛ₀+dψₛ, θₛ₀+dθₛ, φₛ₀+dφₛ). The rotation R_{M}^{V}, non-linear as a function of the unknowns ψₛ, θₛ and φₛ, is written in linear form as a function of the increments (dψₛ, dθₛ, dφₛ) as:

$${R}_{M}^{V} = {R}_{{ψ}_{s 0}} {R}_{{θ}_{s 0}} {R}_{{φ}_{s 0}} + {R}_{{ψ}_{s 0}}^{′} \cdot d {ψ}_{s} + {R}_{{θ}_{s 0}}^{′} \cdot d {θ}_{s} + {R}_{{φ}_{s 0}}^{′} \cdot d {φ}_{s}$$

$${R}_{M}^{V} = {R}_{M 0}^{V} + {r}_{{ψ}_{s 0}} {R}_{{θ}_{s 0}} {R}_{{φ}_{s 0}} . d {ψ}_{s} + {R}_{{ψ}_{s 0}} {r}_{{θ}_{s}} {R}_{{φ}_{s 0}} \cdot d {θ}_{s} + {R}_{{ψ}_{s 0}} {R}_{{θ}_{s 0}} {r}_{{φ}_{s 0}} . d {φ}_{s}$$

$${r}_{{ψ}_{s 0}} = {( \frac{\partial {R}_{{ψ}_{s}}}{\partial {ψ}_{s}} )}_{{ψ}_{s} = {ψ}_{s 0}} = ( \begin{matrix}- sin {ψ}_{s 0} & - cos {ψ}_{s 0} & 0 \\ cos {ψ}_{s 0} & - sin {ψ}_{s 0} & 0 \\ 0 & 0 & 0\end{matrix} )$$

$${r}_{{θ}_{s 0}} = ( \begin{matrix}- sin {θ}_{s 0} & 0 & cos {θ}_{s 0} \\ 0 & 0 & 0 \\ - cos {θ}_{s 0} & 0 & - sin {θ}_{s 0}\end{matrix} ) ;$$

$${r}_{{φ}_{s 0}} = ( \begin{matrix}0 & 0 & 0 \\ 0 & - sin {φ}_{s 0} & - cos {φ}_{s 0} \\ 0 & cos {φ}_{s 0} & - sin {φ}_{s 0}\end{matrix} )$$

that for the magnetic orientation, the coefficients(αₖ, βₖ) being small, the compass orientation M is written to first order in the linear form:

$$M = ( \begin{matrix}cos {θ}_{c} cos {ψ}_{m} \\ cos {θ}_{c} sin {ψ}_{m} \\ - sin {θ}_{c}\end{matrix} ) + {{\sum }^{K}}_{k = 0} ( \begin{matrix}- [ {α}_{k} \cdot sin ( k \cdot {ψ}_{m} ) + \\ {β}_{k} \cdot cos ( k \cdot {ψ}_{m} ) ] sin {ψ}_{m} \\ [ {α}_{k} \cdot sin ( k \cdot {ψ}_{m} ) + \\ {β}_{k} \cdot cos ( k \cdot {ψ}_{m} ) ] cos {ψ}_{m} \\ 0\end{matrix} )$$

For M magnetic orientations associated with M odometric orientations, we then have a non-linear system with 3M equations and 3+2K+1 unknowns. This system can be solved, for example, iteratively in a Levenberg Marquardt or Gauss-Newton approach, by initializing the system with zero value boresighting angles (ψₛ₀, θₛ₀, φₛ₀)=(0,0,0), we then have a linear system with 2K+4 unknowns, that is, at order K=2 the 8 coefficients ψₛ, θₛ, φₛ, α₁, β₁, α₂, β₂ obtained after 3 to 4 Gauss-Newton iterations, for example.

For this method, using an (approximate) value of the local magnetic declination is recommended as soon as it is available within the optronic system. Indeed, the angle ψₛ of vertical or azimuth mounting cannot be distinguished from the coefficient βₛ, to separate them more finely we add at least 1 equation to the previous 3M integrating at least one piece of the a priori information concerning the a priori values, resp. ψₛ₀ and β₀₀, and their associated standard deviation, resp. σ_{ψ}_{ₛ₀} and σ_{β}_{₀₀}:

$${( \frac{{ψ}_{s} - {ψ}_{s 0}}{{σ}_{{ψ}_{s 0}}} )}^{2} = 0 ;$$

$${( \frac{{β}_{0} - {β}_{00}}{{σ}_{{β}_{00}}} )}^{2} = 0$$

Thus, the realization, the acquisition of a scene or a sector as in FR 3 034 553 A, and the use of at least two landmarks for positioning without GNSS enables the user to realize, in complete transparency, and this by means of the joint measurements of the odometer orientations and the compass orientations on the images used for the construction of the odometric compass:
correction of compass measurements for local disturbances due to soft iron and hard iron effects,
characterization of compass and optronic system boresighting, with the mounting between the various optronic system channels pre-determined.

These calibrations give the invention the following advantages:
Reduced set-up time for the optronic system 18.
Capacity to display virtual/augmented reality of vectorial elements on the display screen presenting a direct optical channel or digital images of the channels of the optronic system, even if the system undergoes rapid rotational movements or if the user observes extremely homogeneous zones for which it would be difficult to implement a visual goniometer in its localization phase to position an object 14.
Improved localization of object 14 using magnetic compass and distance measurement,
Possibility of moving the optronic system and resuming calculations of object 14 positions with the calibrated magnetic compass without resuming its N-point calibration, as long as the magnetic environment has changed little, and without resuming a calibration procedure to use a goniometer. The accuracy of the object 14 localization is then mainly limited by the angular error contribution of the magnetic compass.

### Help in Selecting Reference Structures

As an optional addition, the method described allows to assist in the selection of reference features. An example of landmark selection is described below.

The user is optionally guided in their selection of the reference elements 12 as soon as the optronic system 18 elaborates an approximate value of its position.

The acquisition of a new reference element 12 allows the optronic system 18 to refine its position, the relevance of the aid is susceptible to be refined after each new acquisition.

The reference elements 12 can be extracted and accessed in the following 3 modes:
The reference structure notebook mode.
The GIS mode when extracted from integrated geographic products.
The mixed notebook and GIS mode.

The choice of landmark can be guided according to the geographical proximity criteria.
For the notebook/mixed mode, the choice of landmark can be guided by:
   Its zone of proximity to the position of the optronic system (geographic mask and zone query on the reference book to filter the candidate reference elements 12 according to their coordinates),
   Its distance from the optronic system 18: a distance mask can be predefined in terms of optical visibility and another in terms of telemetry range.
   Its angular deviation from the current orientation of the optronic system 18, or from a particular orientation chosen by the user. The orientation of the reference elements 12 in the notebook, allowing them to be found:
   within the field of view (FOV) of the current channel in use, to within angular errors.
   outside the FOV, presenting an angular interval:
      small enough to be visited with a small rotation of a few FOVs,
      large enough, by several FOVs, to suggest reaching the nearest reference element 12. In this case, directions (azimuth, elevation) can be materialized in the imager.
In notebook/mixed mode, the choice of landmarks can be guided in the same way as before, by displaying more structure indices notably on the orthoimage.

The choice of landmarks can also be guided according to the performance criteria.

A major aspect being to meet the following criteria, having an (approximate) position:
In notebook/mixed mode, which next reference element 12 from the notebook to choose, and with which instrument type(s) to carry out the measurement, with a view to maximizing the performance of the new position that would be estimated using this new information (point and instrument measurement(s)).
In GIS mode, the user has considerable latitude in the choice of points, which are not known in advance, rather than indicating a point to choose, a zone accessing the best performance through choosing 1 or even 2 new landmarks. In this mode, the user can benefit from a preliminary preparation that consists of carrying out a semantic segmentation of the on-board orthoimages; the on-board semantic information may:
   At least indicate the geological nature of the zones (forest, urban, river) in the area
   At best, indicate zones of high probability of finding vertically extending visible structures (buildings, trees);
In mixed mode, the possibilities of the 2 previous modes can be used.
In all modes, reference structures can also benefit by being filtered in terms of inter-visibility, as long as an approximate position of 18 is known, and ideally a DEM is available in the absence of a DTM.

The type of reference elements 12 chosen by the user comprises the point positions extracted from the reference elements 12. The extraction can be limited to:
A single point, in which case the reference structure is referred to as a landmark point, after having been assigned geographic coordinates
   and their associated errors, that could be, for example, the top of a water tower or other type of very high building and presenting a marked top that can be telemetered if required, the corner of a building, the asperity of a rock or prominent man-made mountain structure,
Two points of a structure, extracted from a geographic product in planar representation (map or digital reference image) which will then be supported by a segment such as the vertical or horizontal edge of a building, the edge of a road, a sidewalk, the edge or center of a path, a hillside, etc. The extremities of the segment, defined by the two extreme designations in the geographic reference product, are characterized in altitude according to the DTM/DEM, and the errors on these extremities according to the metadata of the geographic product. Its correspondence to one or more images of the optronic system 18 is achieved by designating extremities in the optronic image that do not necessarily physically correspond to those designated in the reference image.

The choice between these two point/segment representations is made according to the products to be accessed. In the case of access to a geographical product, the choice between a point or segment representation depends on the structure of the elements present in the scene 10. Three possible choices are presented, depending on whether:
The user has access to a sufficient number of remarkable points that are both discernible in the optronic image and in the digital reference image and can be extracted quickly and unambiguously; they then work in reference point or landmark mode.
The user does not access any points as above but distinguishes one or more linear structures in the scene 10 having at least one part in common in the optronic image and in the digital reference image; the segment designated by 2 ends in the optronic image and 2 other ends in the reference image is then privileged. The ends of the 2 segments thus extracted do not correspond to each other, but the important thing is that these segments define the same spatial direction in 10.

The user can distinguish one or more structures 12 that are both point-like and linear; and can then designate the 2 types of structure, and the processing in the calculation unit 28 takes care of exploiting these 2 types of primitive association to calculate the position of 18 and the attitude of its goniometer, if available.

### Help in Choosing Measurements

As an optional addition, the calculation unit 28 is able to help choose from among the instruments available in the measurement module 26, with a view to improving performance by acquiring a specific reference element 12. This procedure allows the measurements to be acquired and filtered for processing in the optronic system 18. The following criteria are preferably applied, namely the criteria:
Performance objectives, as a magnetic compass describes a less precise location than a telemeter, whereas a telemeter and/or goniometer are likely to provide correct quality as soon as 2 or 3 landmarks are used.
instrument availability, a visual or mechanical goniometer is not necessarily accessible on the optronic system 18, the first because it is difficult to use on a scene 10 appearing homogeneous in the images, the second because it adds a weight constraint to the system 18.
opportunity, as the use of a magnetic compass and telemeter on a single structure 12 will result in a position error as soon as the reference element 12 is some distance (a few hundred meters) away from the optronic system 18.
energy constraints, as a system may have to operate with minimum power consumption, in which case the use of more energy-intensive instruments may be outlawed.
illumination constraints: if the user has to respect an electromagnetic emission discretion constraint, then the telemeter will not be used to illuminate objects 14; a stronger constraint may prohibit it from illuminating all entities in the scene 10, including the reference structures 12.

Furthermore, the minimum number of structures 12 to be acquired depends on the level of security required for the position information. In the following, it is noted DoF is the degree of freedom corresponding to the number of observation equations reduced by the number of parameters to be estimated.

If a 2D position is being estimated, using a DTM to deduce an altitude later on, the number of unknowns to be estimated is 2. It increases to 3 for estimating a spatial position. When using a visual or mechanical goniometer, these numbers need to be increased:
by one unit if you also wish to estimate the azimuth of the zero reading,
by a further 2 units if you also wish to estimate its attitude to determine the spatial attitude of the goniometer.

Also, according to the type of position to be obtained, it will be necessary to have:
for an approximate position, a DoF≥0
for an optimal position; a DoF≥1
for a position having integrity, assuming the potential presence of a single anomaly, a DoF≥2 is required (DoF≥1 to detect it and 2 to identify the erroneous measurement).

### Example of Position and Error Calculation (Goniometer Case)

An example of how to obtain the geometrical locus of possible positions of the optronic system 18 with 1 angular deviation measurement on 2 reference elements 12, the sensitivity of the position locus to the measurement errors and to the geometry of the reference elements 12, and how to obtain the position of the optronic system 18 with 3 reference elements 12 are described successively in the following. Here the process allowing an approximate position to be obtained by processing the angle measurements with the visual goniometer is described. We indicate:
the plane position of optronic system 18 (x₀, y₀) belongs to a circle, locus, under which two landmarks of plane coordinates (x1 , y1) and (x₂, y₂) are seen and measured at angle ΔL₃=|L₂−L₁|. The equation of the circle verifying:

$${( {x}_{0} - {x}_{c3} )}^{2} + {( {y}_{0} - {y}_{c3} )}^{2} = {R}_{c3}^{2}$$

$$with :$$

$${x}_{c3} = \frac{{x}_{1} + {x}_{2}}{2} - \frac{{y}_{2} - {y}_{1}}{2 tan Δ {L}_{3}} ;$$

$${y}_{c3} = \frac{{y}_{1} + {y}_{2}}{2} + \frac{{x}_{2} - {x}_{1}}{2 tan Δ {L}_{3}} ;$$

$${R}_{c3} = \frac{\sqrt{{( {x}_{2} - {x}_{1} )}^{2} + {( {y}_{2} - {y}_{1} )}^{2}}}{2 sin Δ {L}_{3}}$$

the precision with which this locus is obtained depends on the quality of the landmark coordinates and the goniometer reading. Insofar as these 5 quantities can be tainted by bias and noise, we can deduce the bias and noise on the parameters of the circle characterizing the goniometer measurement. In passing, it can be pointed out that metric quality landmarks and a 1 mils quality goniometer give the goniometric circle a quality on the center, of the GNSS class and on the radius, of the telemeter class (<3 m for the example) over a wide angular range (from 40 to 140° for the example). To fix ideas, the covariance on the parameters with 2 landmarks separated by a base B having identical errors on their coordinates σ_{P} which are positioned symmetrically relative to the optronic system:

$${σ}_{{R}_{c} ⊙}^{2} = \frac{1}{{sin}^{2} Δ {L}_{3}} ( \frac{{B}^{2}}{4 {tan}^{2} Δ {L}_{3}} {σ}_{Δ {L}_{3}}^{2} + {σ}_{P}^{2} )$$

$${σ}_{{x}_{c} ⊙}^{2} = \frac{Δ {y}^{2}}{4 {tan}^{4} Δ {L}_{3}} {σ}_{Δ {L}_{3}}^{2} + \frac{1}{2 {sin}^{2} Δ {L}_{3}} {σ}_{P}^{2}$$

$${σ}_{{y}_{c} ⊙}^{2} = \frac{Δ {x}^{2}}{4 {tan}^{4} Δ {L}_{3}} {σ}_{Δ {L}_{3}}^{2} + \frac{1}{2 {sin}^{2} Δ {L}_{3}} {σ}_{P}^{2}$$

$${σ}_{{R}_{c} {x}_{c} ⊙} = - \frac{B Δ y cos Δ {L}_{3}}{4 {sin}^{2} Δ {L}_{3} {tan}^{2} Δ {L}_{3}} {σ}_{Δ {L}_{3}}^{2} - \frac{Δ y}{2 B {sin}^{2} Δ {L}_{3} tan Δ {L}_{3}} {σ}_{P}^{2}$$

$${σ}_{{y}_{c} {R}_{c} ⊙} = - \frac{B Δ x cos Δ {L}_{3}}{4 {sin}^{2} Δ {L}_{3} {tan}^{2} Δ {L}_{3}} {σ}_{Δ {L}_{3}}^{2} + \frac{Δ x}{2 B sin Δ {L}_{3} tan Δ {L}_{3}} {σ}_{P}^{2}$$

$${σ}_{{x}_{c} {y}_{c} ⊙} = \frac{Δ x Δ y}{4 {tan}^{4} Δ {L}_{3}} {σ}_{Δ {L}_{3}}^{2}$$

That is a covariance of

$${Λ}_{3 ⊙} = ( \begin{matrix}{σ}_{{R}_{c}}^{2} & {σ}_{{R}_{c} {x}_{c}} & {σ}_{{y}_{c} {R}_{c}} \\ {σ}_{{R}_{c} {x}_{c}} & {σ}_{{x}_{c}}^{2} & {σ}_{{x}_{c} {y}_{c}} \\ {σ}_{{y}_{c} {R}_{c}} & {σ}_{{x}_{c} {y}_{c}} & {σ}_{{y}_{c}}^{2}\end{matrix} )$$

These expressions contract the notations: α=ΔL₃; Δx=x₂−x₁ et Δy=y₂−y₁
With 3 angle readings Lₙ, and 3 angular differences on 3 landmarks, the position of system 18 is obtained as close as possible to the intersection of the 3 circles; this is unambiguous as long as the circle passing through the 3 landmarks does not pass as close to the position of system 18. To do this, just the following system is solved, in which vₙ represents a small quantity integrating the measurement errors:

(x₀−x_{Cn})²+(y₀−y_{Cn})²=R_{Cn}²+vₙn∈{1,2,3}

Having 3 reference elements 12 and therefore 3 of the above equations, we can, for example, take the average of the 3 equations and subtract it from each of them to find the position as a solution of a linear system.
It is also possible to obtain the precision of the position coordinates (x₀, y₀) of the optronic system 18 by Analysis of Mean and Variance, for example; by differentiating the previous expression:

$$[ \begin{matrix}{x}_{0} - {x}_{c3} & {y}_{0} - {y}_{c3} \\ {x}_{0} - {x}_{c1} & {y}_{0} - {y}_{c1} \\ {x}_{0} - {x}_{c2} & {y}_{0} - {y}_{c2}\end{matrix} ] [ \begin{matrix}dx \\ dy\end{matrix} ] = [ \begin{matrix}{R}_{c3} & {x}_{0} - {x}_{c3} & {y}_{0} - {y}_{c3} \\ {R}_{c1} & {x}_{0} - {x}_{c 1} & {y}_{0} - {y}_{c1} \\ {R}_{c2} & {x}_{0} - {x}_{c2} & {y}_{0} - {y}_{c2}\end{matrix} ] [ \begin{matrix}{dR}_{c3} \\ {dx}_{c3} \\ {dy}_{c3} \\ {dR}_{c1} \\ {dx}_{c1} \\ {dy}_{c1} \\ {dR}_{c2} \\ {dx}_{c2} \\ {dy}_{c2}\end{matrix} ]$$

Noting the 2 matrices of the left J_{Θ} and right J_{M} members; and taking the expectation

$${Λ}_{26} = E ( {[ \begin{matrix}dx \\ dy\end{matrix} ] [ \begin{matrix}dx \\ dy\end{matrix} ]}^{T} ) = {( {J}_{Θ}^{T} {J}_{Θ} )}^{- 1} {J}_{Θ}^{T} {J}_{M} {Λ}_{M} {J}_{M}^{T} {{J}_{Θ} [ {( {J}_{Θ}^{T} {J}_{Θ} )}^{- 1} ]}^{T}$$

Where Λ_{M} is the diagonal block covariance of Λ_{n⊙}:

$${Λ}_{M} = ( \begin{matrix}{Λ}_{3 ⊙} & {0}_{3 \times 3} & {0}_{3 \times 3} \\ {0}_{3 \times 3} & {Λ}_{1 ⊙} & {0}_{3 \times 3} \\ {0}_{3 \times 3} & {0}_{3 \times 3} & {Λ}_{2 ⊙}\end{matrix} )$$

Furthermore, the azimuth of the goniometer zero reading is obtained with 3 readings of angles Lₙ, on three structures 12 of coordinates (xₙ, yₙ), the azimuth corresponding to the goniometer ‘zero’ reading, and allowing it to be transformed into an odometric compass, is obtained according to the expression:

$$tan {G}_{0} = \frac{{\sum }_{n = 1}^{N = 3} ( {y}_{n} cos {L}_{n} - {x}_{n} sin {L}_{n} ) sin Δ {L}_{n}}{{\sum }_{n = 1}^{N = 3} ( {y}_{n} sin {L}_{n} + {x}_{n} cos {L}_{n} ) sin Δ {L}_{n}}$$

The position of the optronic system can also be determined directly by means of 3 goniometer measurements on three reference elements (12), by the classic 3-point bearing method using the 3 angular measurement deviations of the goniometer. In the case of 3 reference objects for which the goniometer measurements are available:
The bearing value of the goniometer is determined in order to transform it into a compass and to be able to locate objects (14) in the scene (10) more accurately at a later date,
The covariance on the approximate position is determined by means of the errors on the reference objects and the errors on the angular deviations of the goniometer in order to:
   initialize the optimal position calculation of the optronic system by adding measurements on other reference elements (12),
   implement position integrity measurements from different optronic system modalities.

1. A method of determining at least one position by an optronic system in a scene, the scene comprising reference elements of known geographic coordinates, the optronic system comprising the following elements integrated into said optronic system:
a. a digital imager,
b. a memory in which is stored, for at least each reference element of the scene, an indicator representative of said point associated with the geographic coordinates of said point,
c. a display element for displaying the indicators stored in the memory,
d. a measurement module comprising at least one element chosen from among: a compass, a goniometer and a telemeter,
e. a calculation unit,
the method being implemented by the elements integrated in the optronic system and comprising:
a. a data collection phase relative to at least one reference element of the scene, the collection phase comprising, for each reference element, the steps of:
i. pointing, by the digital imager, of the reference element in the scene,
j. acquisition, by the measurement module, of at least one measurement relative to the reference element pointed in the scene following reception of a first acquisition command,
k. pointing, on the display element, from among the stored indicators, an indicator representative of the reference element pointed in the scene,
l. acquisition, by the calculation unit, of the geographic coordinates associated with the pointed indicator following reception of a second acquisition command,
m. storage of a reference datum comprising the at least one acquired measurement and the acquired geographic coordinates,
b. a phase of determining the position of the optronic system as a function of the reference data stored for the at least one reference element.

2. The method according to claim 1, wherein the indicators stored in the memory are points geo-referenced on geographic data, the geographic data comprising at least one element from among: an orthoimage of the scene, a digital terrain model of the scene, a cartography of the scene and a digital elevation model of the scene.

3. The method according to claim 1, wherein the step of pointing an indicator comprises the display on the display element:
a. of the image of the scene comprising the reference element pointed by the digital imager, and
b. indicators stored in the memory.

4. The method according to claim 1, wherein the phase of determining the position of the optronic system comprises the selection, by the calculation unit, of a position determination technique from among a set of position determination techniques as a function of the nature of the element or elements of the measurement module having acquired the at least one measurement corresponding to the reference data, the position of the optronic system being determined on the basis of the selected determination technique.

5. The method according to claim 1, wherein each element of the measurement module is associated with a measurement uncertainty and each geographic coordinate is associated with an uncertainty on said geographic coordinate, the phase of determining the position of the optronic system comprising the determination of an uncertainty on the position determined as a function of the corresponding uncertainties on the at least one element of the measurement module and on the geographic coordinates.

6. The method according to claim 1, wherein the phase of determining the position of the optronic system comprises calculating an approximate position of the optronic system as a function of stored reference data and calculating an optimum position of the optronic system from the approximate position and the set of reference data.

7. The method according to claim 6, wherein the phase of determining the position of the optronic system comprises evaluating the integrity of the reference data and determining a position having integrity as a function of only the reference data evaluated as being of integrity, and the calculated optimum position.

8. The method according to claim 1, wherein the optronic system comprises a receiver for geolocation and navigation by a satellite system, called GNSS receiver, the method comprising a phase of determining the position of the optronic system by the GNSS receiver, called GNSS position, and validating or not the GNSS position as a function of a position of the optronic system determined via the reference data.

9. The method according to claim 1, wherein the measurement module comprises an odometric goniometer or an odometric compass, at least one measurement acquired relative to the reference elements being an orientation measurement, the measurement acquisition step comprising:
a. acquisition of a series of images of the scene, the series of images comprising at least one image of the reference element, the images of the series of images overlapping in pairs, and
b. determination of, by the odometric goniometer or odometric compass, an orientation of the reference element relative to the optronic system as a function of the series of images of the scene acquired.

10. The method according to claim 1, wherein the method comprises a phase of determining the position of an object of the scene as a function of the determined position of the optronic system, an obtained orientation of the object relative to the optronic system and an obtained distance between the object and the optronic system.

11. The method according to claim 10, wherein the phase of determining the position of the object comprises the steps of:
a. acquisition of a series of images of the scene, the series of images comprising at least one image of the object, the images of the series of images overlapping in pairs, and
b. determination of the orientation of the object relative to the optronic system as a function of the series of images of the scene.

12. The method according to claim 10, wherein the measurement module of the optronic system comprises at least one compass, the orientation of the object being obtained by a measurement acquired by the compass when the object is pointed by the digital imager.

13. The method according to claim 10, wherein:
a. at least one element of the measurement module of the optronic system is a telemeter, the distance between the object and the optronic system being obtained by a measurement acquired by the telemeter when the object is pointed by the digital imager, or
b. the distance between the object and the optronic system is the distance between the determined position of the optronic system and the intersection of a predetermined straight line with the ground of a digital terrain model, the predetermined straight line passing through the determined position of the optronic system and having as its orientation the obtained orientation of the object relative to the optronic system.

14. The method according to claim 1, wherein the optronic system is selected from among: a pair of optronic binoculars and an optronic camera.

15. The method according to claim 1, in which at least one element of the measurement module is a magnetic compass, the method comprising a phase of automatic calibration of the declination, the measurements and boresighting of the magnetic compass by means of measurements acquired for at least two reference elements, when said reference elements are pointed by the digital imager.

16. An optronic system for determining at least one position by an optronic system in a scene, the scene comprising reference elements of known geographic coordinates, the optronic system comprising the following elements integrated into said optronic system:
a. a digital imager,
b. a memory wherein is stored, for at least each reference element of the scene, an indicator representative of said point associated with the geographic coordinates of said point,
c. a display element for displaying the indicators stored in the memory,
d. a measurement module comprising at least one element chosen from among: a compass, a goniometer and a telemeter,
e. a calculation unit,
the optronic system being configured to implement a method according to claim 1.

17. The method according to claim 2 wherein the memory comprising, in addition to the indicators of the reference elements, the indicators of all the points geo-referenced on the geographic data.

18. The method according to claim 8, wherein when the GNSS position has been validated, the method comprises merging the GNSS position with the position of the optronic system determined via the reference data used for comparison so as to obtain a definitive position for the optronic system.
